(19) United States
(12) Patent Application Publication
(10) Pub. No.: US 2026/0211264 A1
(43) Pub. Date: Jul. 23, 2026

(54) GLASSES AND GLASSES ASSEMBLY

(71) Applicant: BEIJING UNICORN TECHNOLOGY CO., LTD., Beijing (CN)

(72) Inventors: Jun Wang, Beijing (CN); Yang Liu, Beijing (CN)

(21) Appl. No.: 19/142,201

(22) PCT Filed: Nov. 27, 2023
(86) PCT No.: PCT/CN2023/134508

§ 371 Date: Jun. 21, 2025

(30) Foreign Application Priority Data
Dec. 29, 2022 (CN) 202211710840.8

(51) Int. Cl. G02C 5/06; G02C 5/12

(52) U.S. Cl. CPC G02C 5/06; G02C 5/12

(57) ABSTRACT

Embodiments of the present disclosure disclose glasses (100) and a glasses assembly. A specific implementation is as follows: the glasses (100) include a first frame portion(1a), a second frame portion(1b), and a bridge (2). The bridge(2)is located between the first frame portion (1a) and the second frame portion (1b), and the bridge (2) connects the first frame portion (1a) and the second frame portion (1b); the bridge (2) is provided with a nose piece slot (21) and an elastic fixing assembly (23), wherein the elastic fixing assembly (23) has an abutting member (231) and an elastic member (232), the abutting member (231) having a smooth surface; and the elastic fixing assembly (23) is configured such that under the action of the elastic member (232), the abutting member (231) extends into the nose piece slot (21), and under the action of an external force, the abutting member (231) draws back in a direction away from the nose piece slot (21). The glasses (100) are configured such that in a state where the insertion portion (2201) of the nose piece (200) is inserted into the nose piece slot (21), the abutting member (231) abuts against the insertion portion (2201) to secure the nose piece. The glasses assembly has the glasses (100) and a nose piece, the nose piece (200) having an insertion portion (2201), and in a state where the insertion portion (2201) is inserted into the nose piece slot (21), an elastic fixing assembly (23) abuts against the insertion portion (2201) to secure the nose piece (200).

### TECHNICAL FIELD

The present disclosure claims priority to Chinese Patent Application No. CN202211710840.8, filed with the China National Intellectual Property Administration on Dec. 29, 2022, and entitled “Glasses and Glasses Assembly”, which is incorporated herein by reference in its entirety.

The present disclosure relates to the technical field of electronic products, in particular to glasses and a glasses assembly.

### BACKGROUND

After wearing smart glasses, different users have varying distances from the nose bridge to a frame. Therefore, it is necessary to provide nose pieces of corresponding sizes for different users to facilitate adjustment of a frame height to a position for an optimal user experience. A nose piece typically has an insertion portion, which can be inserted into a slot in the middle of the frame so as to be snap-fixed to a snap-fit mechanism of the frame. The snap-fit structure between the nose piece and the frame is not easy to disengage, making it difficult to pull out the nose piece when the nose piece needs to be detached, leading to a poor use experience.

### SUMMARY

Embodiments of the present disclosure provide glasses and a glasses assembly.

According to an aspect of embodiments of the present disclosure, glasses are provided, the glasses including a first frame portion, a second frame portion, and a bridge. The bridge is located between the first frame portion and the second frame portion, and the bridge connects the first frame portion and the second frame portion; the bridge is provided with a nose piece slot and an elastic fixing assembly, wherein the elastic fixing assembly has an abutting member and an elastic member, the abutting member having a smooth surface; and the elastic fixing assembly is configured such that under the action of the elastic member, the abutting member extends into the nose piece slot, and under the action of an external force, the abutting member draws back in the direction away from the nose piece slot. The glasses are configured such that in a state where the insertion portion of the nose piece is inserted into the nose piece slot, the abutting member abuts against the insertion portion to secure the nose piece.

According to another aspect of embodiments of the present disclosure, there is provided a glasses assembly, the glasses assembly having glasses and a nose piece, the nose piece having an insertion portion, wherein in a state where the insertion portion is inserted into a nose piece slot, an elastic fixing assembly abuts against the insertion portion to secure the nose piece.

The technical solution of the present disclosure is further described in detail below in conjunction with the accompanying drawings and embodiments.

### BRIEF DESCRIPTION OF THE DRAWINGS

The drawings constituting a part of the specification describe embodiments of the present disclosure, and together with the description, serve to explain the principle of the present disclosure.

With reference to the accompanying drawings, the present disclosure can be understood more clearly according to the following detailed description, in which:

FIG. 1 shows a perspective structural diagram of a glasses assembly according to embodiments of the present disclosure;

FIG. 2 shows a sectional view of a glasses assembly in which a nose piece is mounted to glasses according to embodiments of the present disclosure;

FIG. 3 shows a sectional view of a bridge part in FIG. 2;

FIG. 4 shows a first sectional view of a bridge of glasses according to embodiments of the present disclosure;

FIG. 5 shows a state diagram illustrating an insertion portion of a nose piece of a glasses assembly is inserted into a nose piece slot according to embodiments of the present disclosure;

FIG. 6 shows a second sectional view of a bridge of glasses according to embodiments of the present disclosure;

FIG. 7 is a structural diagram of FIG. 6 with an elastic fixing assembly part removed;

FIG. 8 shows a structural diagram of an elastic member in glasses according to embodiments of the present disclosure;

FIG. 9 shows a first structural diagram of a nose piece of a glasses assembly according to embodiments of the present disclosure; and

FIG. 10 shows a second structural diagram of a nose piece of a glasses assembly according to embodiments of the present disclosure.

### REFERENCE NUMERALS

100, glasses; 1a, first frame portion; 1b, second frame portion; 2, bridge; 21, nose piece slot; 22, mounting slot; 221, main slot; 222, necked slot; 223, limiting step surface; 224, tapered wall; 23, elastic fixing assembly; 231, abutting member; 2311, main body portion; 2312, pressing portion; 232, elastic member; 2321, cylindrical body; 2322, end plate; 2323, spring; 2324, protruding post; 24, mounting opening; 25, cover; 26, fastener; 3, temple; 200, nose piece; 210, contact portion; 220, bracket; 2201, insertion portion; 2201a, positioning fit hole.

It is to be noted that these drawings and text description are not intended to limit the scope of conception of the present invention in any way, but to explain the concepts of the present invention for those skilled in the art by referring to specific embodiments.

### DETAILED DESCRIPTION

To make the objects, technical solutions and advantages of embodiments of the present invention clearer, the technical solutions in the embodiments will be described clearly and completely with reference to the drawings in the embodiments of the present invention. The following embodiments are used for illustrating the present invention, but not limiting the scope of the present invention.

In description of the present invention, it should be noted that orientation or location relations denoted by the terms “upper”, “lower”, “inner”, “outer”, etc. are orientation or location relations based on illustration in the drawings, are only intended to facilitate describing the present invention and simplify description, instead of indicating or implying the denoted apparatuses or elements must have specific orientations and are constructed and operated in specific orientations, and thus they should not be construed as limiting the present invention.

In description of the present invention, it should be noted that unless otherwise explicitly specified and defined, the terms “mount” and “connect” should be construed broadly. For example, such a term may denote fixed connection, or detachable connection, or integrated connection; mechanical connection, or electric connection; direct connection, or connection via an intermediate medium. For those of ordinary skill in the art, specific meanings of the above-mentioned terms in the present invention may be construed according to specific conditions.

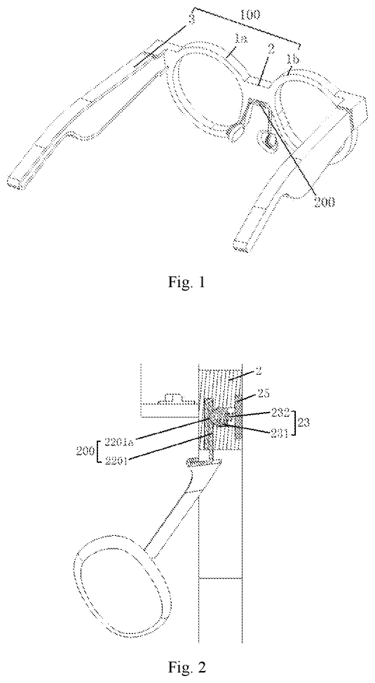

Referring to FIGS. 1, 2 and 3, Embodiment 1 of the present disclosure provides glasses 100. The glasses 100 include a frame. The frame has a nose piece slot 21 configured for attachment and detachment of a nose piece 200, and an elastic fixing assembly 23. In a state where an insertion portion 2201 of the nose piece 200 is inserted into the nose piece slot 21, the elastic fixing assembly 23 abuts against the insertion portion 2201 of the nose piece 200 to secure the nose piece 200. When the nose piece 200 needs to be detached, the nose piece 200 can be pulled out by an external force.

In embodiments of the present disclosure, with the elastic fixing assembly 23 provided in the frame, the fixing method, which uses the elastic fixing assembly 23 to extrude and secure the nose piece 200, facilitates the attachment and detachment of the nose piece 200 while simplifying the design of the nose piece 200. On the one hand, the nose piece 200 can be smoothly pulled out of the nose piece slot 21, avoiding the problem that the nose piece 200 is difficult to pull out due to snap-fit connection between the insertion portion 2201 and the frame by a snap-fit structure. On the other hand, the nose piece 200 may be designed with a simple shape, eliminating the need for a complex structure to facilitate the fixation and detachment of the nose piece 200.

Referring to FIG. 1, the frame includes a first frame portion 1a, a second frame portion 1b, and a bridge 2. The bridge 2 is located between the first frame portion 1a and the second frame portion 1b, and the bridge 2 connects the first frame portion 1a and the second frame portion 1b. The bridge 2 is provided with the nose piece slot 21 and the elastic fixing assembly 23. The elastic fixing assembly 23 has an abutting member 231 and an elastic member 232. The abutting member 231 may have a smooth surface. The elastic fixing assembly 23 is configured such that under the action of the elastic member 232, the abutting member 231 extends into the nose piece slot 21, and under the action of an external force, the abutting member 231 draws back in the direction away from the nose piece slot 21. The glasses 100 are configured such that in a state where the insertion portion 2201 of the nose piece 200 is inserted into the nose piece slot 21, the abutting member 231 abuts against the insertion portion 2201 to secure the nose piece 200.

Exemplarily, the glasses 100 are further configured such that during movement of the insertion portion of the nose piece away from the nose piece slot 21, the nose piece applies an external force to the abutting member 231, causing the abutting member 231 to draw back in the direction away from the nose piece slot 21 to release the nose piece.

Understandably, the above-described external force that causes the abutting member 231 to draw back in the direction away from the nose piece slot 21 may be applied by the nose piece to the abutting member 231. For example, the abutting member 231 is in direct contact with the nose piece, for positioning the nose piece, and the nose piece may apply the external force directly to the abutting member 231, causing the abutting member 231 to move to release the nose piece.

In embodiments of the present disclosure, compared with the nose piece 200 (compared with a solution of providing an elastic member on the nose piece), the bridge 2 can provide a larger space, such that the elastic member 232 of the elastic fixing assembly 23 can be larger, which is conducive to increasing the elasticity and improving the effect of clamping and securing the nose piece 200. With the larger elastic member 232, better durability can be achieved. The abutting member 231 has a smooth surface. For example, the abutting member 231 may be provided with a smooth curved surface. Referring to FIGS. 4 and 5, in a state where the insertion portion 2201 of the nose piece 200 is being inserted into the nose piece slot 21, the insertion portion 2201 comes into contact with the smooth surface of the abutting member 231, and can smoothly push away the abutting member 231 such that the abutting member 231 compresses the elastic member 232 and draws back in the direction away from the nose piece slot 21 to create a space for the nose piece 200 to enter the nose piece slot 21. After the insertion portion 2201 is inserted in place, under an elastic force of the elastic member 232, the abutting member 231 abuts against the insertion portion 2201, increasing a frictional force among the insertion portion 2201, the abutting member 231 and the nose piece slot 21, such that the insertion portion 2201 is not prone to dislodgement. When the nose piece 200 needs to be detached, a force is applied to pull the nose piece 200 outwards. Since the smooth surface of the abutting member 231 is in contact with the insertion portion, and there is no snap-fit structure between the abutting member 231 and the insertion portion 2201, the insertion portion 2201 can be pulled out smoothly. No unlocking operation is required between the glasses 100 and nose piece 200. Attachment and detachment can be achieved by direct insertion and removal operations, which is convenient to operate and provides a good use experience.

In some possible implementations, referring to FIGS. 4 and 5, the bridge 2 is provided with a mounting slot 22. The extension direction of the mounting slot 22 is perpendicular to the extension direction of the nose piece slot 21, and the mounting slot 22 is in communication with the nose piece slot 21. The elastic member 232 is arranged in the mounting slot 22, and the abutting member 231 is slidably connected to the mounting slot 22. Under the action of the elastic member 232, the abutting member 231 partially extends into the nose piece slot 21.

Understandably, the extension direction of the nose piece slot 21 may be the thickness direction of the frame, or may be the direction perpendicular to the thickness direction of the frame.

In this implementation, compared with the nose piece 200, the bridge 2 can provide a larger space, and the bridge 2 is more suitable for providing the nose piece slot 21 and mounting slot 22. The extension direction of the mounting slot 22 and the extension direction of the nose piece slot 21 are perpendicular to each other, the insertion/removal direction of the nose piece 200 is perpendicular to the sliding direction of the abutting member 231. Understandably, the term “perpendicular” in the present disclosure does not encompass only an absolute perpendicular relationship, as long as the two are substantially perpendicular. Under the elastic force of the elastic member 232, the abutting member 231 substantially perpendicularly abuts against the insertion portion 2201. A pressure applied by the abutting member 231 to the insertion portion 2201 is perpendicular to the length direction of the insertion portion 2201. The pressure has no component in the plane of the insertion portion 2201, thereby maximizing the frictional force between the insertion portion 2201 and the abutting member 231 and an inner wall defining the nose piece slot 21, so that the nose piece 200 can be stably mounted to the glasses 100 and is not prone to dislodgement.

In some possible implementations, referring to FIG. 4, the mounting slot 22 has a main slot 221 and a necked slot 222. The main slot 221 is in communication with the nose piece slot 21 by the necked slot 222. A diameter of the necked slot 222 is smaller than that of the main slot 221. The abutting member 231 is slidably arranged in the main slot 221. The elastic member 232 is located in the main slot 221, with one end of the elastic member 232 abutting against the abutting member 231, such that the abutting member 231 is partially limited within the main slot 221 and partially extends into the nose piece slot 21 through the necked slot 222.

In this implementation, providing the necked slot 222 can limit the abutting member 231, so that the abutting member 231 does not completely separate from the main slot 221. There is always a portion of the abutting member 231 retained in the main slot 221. In a process of inserting or pulling out the insertion portion 2201, the main slot 221 can function as a guide for the abutting member 231. The abutting member 231 can move, such as reciprocate, in the thickness direction of the frame, to compress or release the elastic member. Referring to FIG. 5, in the process of inserting the insertion portion 2201 of the nose piece 200 into the nose piece slot 21, the end of the insertion portion 2201 first contacts the end of the abutting member 231 facing away from the elastic member 232. As the insertion portion 2201 continues to be inserted, the abutting member 231 can retract accordingly along the extension direction of the main slot 221 and draw back in the direction away from the nose piece slot 21. In the process of pulling out the nose piece 200, under the elastic force of the elastic member 232, the abutting member 231 gradually and steadily protrudes along the extension direction of the main slot 221 and extends into the nose piece slot 21.

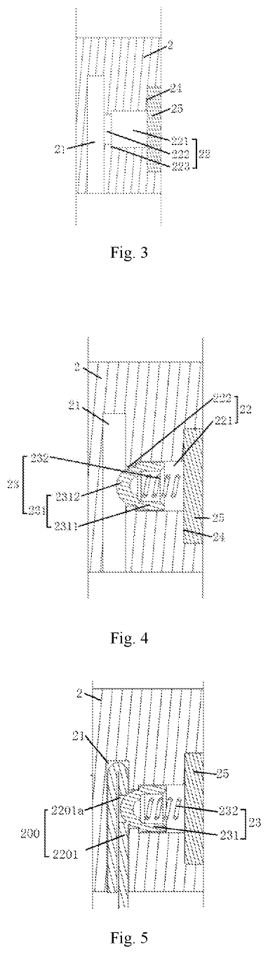

In some possible implementations, referring to FIGS. 3 and 4, an inner wall defining the necked slot 222 is straight and cylindrical, and a limiting step surface 223 is formed between the necked slot 222 and the main slot 221. The limiting step surface 223 is a closed annular surface, and the limiting step surface 223 lies in a plane. The abutting member 231 may be provided with a mating step surface corresponding to the limiting step surface 223, and the mating step surface may also be a closed annular surface. The limiting step surface 223 and the mating step surface have the same shape and size. When the elastic member 232 pushes the abutting member 231 to slide to a limit position, the mating step surface fits against the limiting step surface 223.

Referring to FIGS. 4 and 5, the nose piece slot 21 has a first side inner wall and a second side inner wall, the first side inner wall and the second side inner wall being spaced apart. A distance between the first side inner wall and the second side inner wall is not less than a thickness of the insertion portion 2201 of the nose piece 200. The insertion portion 2201 may be inserted between the first side inner wall and the second side inner wall. The first side inner wall is provided with an opening in communication with the necked slot 222, and the second side inner wall may be a flat and straight wall. When the elastic member 232 pushes the abutting member 231 to slide to the limit position, there may be a gap between the end of the abutting member 231 and the second side inner wall to facilitate pushing away the abutting member 231 on a side of the abutting member 231 facing away from the elastic member 232 during insertion of the insertion portion 2201 of the nose piece 200 into the nose piece slot 21, so that the insertion portion is smoothly and completely inserted in the nose piece slot 21.

In some optional embodiments, the abutting member 231 may be a cap. The cap has a top end and a cavity. The cavity of the cap is configured to accommodate at least a portion of the elastic member. Under the action of the elastic member, the top end of the cap extends into the nose piece slot.

In some optional embodiments, the abutting member includes a main body portion 2311 and a pressing portion 2312. The main body portion 2311 has an outer diameter different from that of the pressing portion 2312, and is provided with a recessed portion located at the end facing away from the pressing portion 2312. The recessed portion is configured to accommodate the elastic member 232. The pressing portion 2312 extends into the nose piece slot and has a smooth convex outer surface.

Referring to FIGS. 4 and 5, the abutting member 231 may include a main body portion 2311 and a pressing portion 2312. The cross-sectional diameter of the main body portion 2311 is greater than the inner diameter of the necked slot 222, and the cross-sectional diameter of the pressing portion 2312 is less than the inner diameter of the necked slot 222. The main body portion 2311 is slidably arranged in the main slot 221, and the pressing portion 2312 is connected to the main body portion 2311. The elastic member 232 abuts against the main body portion 2311, such that the main body portion 2311 may rest against the necked slot 222 and the pressing portion 2312 may extend through the necked slot 222 into the nose piece slot 21. An annular mating step surface may be formed between the main body portion 2311 and the pressing portion 2312. The main body portion 2311 may be provided with an elastic member limiting portion, and the end of the elastic member 232 can be limited within the elastic member limiting portion, so that the elastic member 232 can keep applying the elastic force to the same part of the main body portion 2311, thereby avoiding deflection of the abutting member 231 under the action of the elastic force. For example, a recessed portion (recess) may be provided at the end of the main body portion 2311 facing away from the pressing portion 2312, and the elastic member 232 may be a spring. The extension direction of the spring is the same as the extension direction of the main slot 221. One end of the spring extends into the recess (recessed portion) of the main body portion 2311. The recess may extend along a central axis of the abutting member 231, so that the direction of the force applied by the elastic member 232 to the main body portion 2311 can pass through a center of gravity of the abutting member 231, thereby facilitating smooth movement of the abutting member 231 along the main slot 221 and making it less prone to tilt. The pressing portion 2312 may have a smooth convex outer surface. In a state where the insertion portion 2201 of the nose piece 200 is inserted into the nose piece slot 21, the convex outer surface of the pressing portion 2312 is pressed against the insertion portion 2201.

The extension direction of the nose piece slot 21 is substantially perpendicular to the direction of the axis of the abutting member 231. During insertion of the insertion portion 2201 of the nose piece 200 into the nose piece slot 21, the movement direction of the insertion portion 2201 is substantially perpendicular to the direction of the axis of the abutting member 231. In order to facilitate smoothly pushing away the abutting member 231 during insertion of the insertion portion 2201 into the nose piece slot 21, the convex outer surface of the pressing portion 2312 may be configured as a smooth curved surface or an inclined surface. Before the insertion portion 2201 is inserted into the nose piece slot 21, an avoidance gap that facilitates pushing away the abutting member 231 is formed between a peripheral side of the curved surface and the second side inner wall defining the nose piece slot 21. After the insertion portion 2201 is inserted into the nose piece slot 21, it can smoothly move to the avoidance gap, and the insertion portion 2201 comes into contact with the curved surface. A force applied by the insertion portion 2201 to the curved surface has a component force along the direction of the axis of the abutting member 231, so the abutting member 231 can be smoothly pushed away, causing the abutting member 231 to retract toward the main slot 221. The insertion portion 2201 is finally stably inserted into the nose piece slot 21, and the abutting member 231 abuts against the insertion portion 2201 under the action of the elastic member 232 to secure the nose piece 200. The surface of the curved convex outer surface has a smooth transition, which facilitates smoother insertion and removal of the insertion portion 2201, thereby making the operations convenient and providing a good use experience.

In a possible implementation, referring to FIG. 7, the inner wall defining the necked slot 222 is a tapered wall 224 tapering in the direction from the main slot 221 to the nose piece slot 21.

The abutting member 231 may include a main body portion with a diameter larger than a wide opening of the tapered wall 224 and a pressing portion with a diameter smaller than a narrow opening of the tapered wall 224. There is a transition portion between the main body portion 2311 and the pressing portion 2312. An outer surface of the transition portion is tapered, and the shape and dimensions of the outer surface of the transition portion match those of the inner wall defining the necked slot 222. When the elastic member 232 pushes the abutting member 231 to the limit position, the outer surface of the transition segment of the abutting member 231 fully and tightly fits against the tapered wall 224. The tapered wall 224 has a guiding function. During gradual movement of the abutting member 231 to the limit position, a space within the tapered wall 224 gradually decreases, which can automatically correct deflection of the abutting member 231, so that the abutting member 231 can be kept perpendicular to the insertion portion 2201, thereby facilitating pressing and securing the insertion portion 2201.

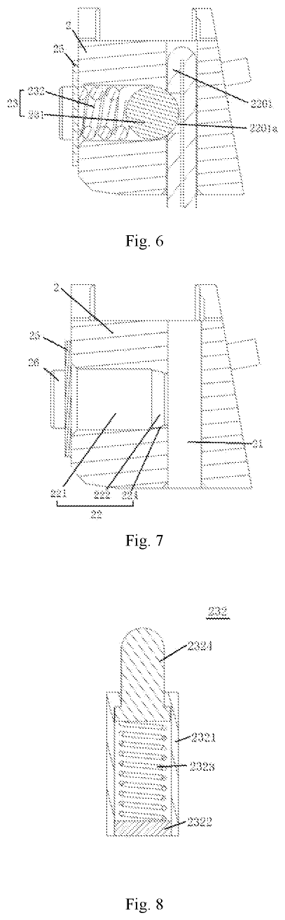

In a possible implementation, referring to FIGS. 6 and 7, the inner wall defining the necked slot 222 is a tapered wall 224 tapering in the direction from the main slot 221 to the nose piece slot 21. The tapered wall 224 may be arc-shaped, and the abutting member 231 may be spherical. The diameter of the abutting member 231 is greater than the inner diameter of the necked slot 222, and the diameter of the abutting member 231 is less than the inner diameter of the main slot 221. Under the abutment of the elastic member 232, the abutting member 231 rests against the necked slot 222, i.e., a part of an arc surface of the spherical abutting member 231 fits against the arc-shaped necked slot 222, and the abutting member 231 partially extends into the nose piece slot 21.

The tapered wall 224 is further configured to be arc-shaped to match the outer surface of the spherical abutting member 231. Configuring the abutting member 231 to be spherical can make the mating structure of the abutting member 231 and the insertion portion 2201 more stable. The diameter of the main slot 221 matches the diameter of the abutting member 231. During the movement of the abutting member 231 along the main slot 221, even if the abutting member 231 rolls, both the position of the abutting member abutting against the insertion portion 2201 and the pressure applied by the abutting member to the insertion portion 2201 remain constant, thereby maintaining stable mating performance of the glasses 100 and the nose piece 200 during insertion and removal.

In a possible implementation, referring to FIG. 4, the bridge 2 is provided with a mounting opening 24 in communication with the mounting slot 22. The mounting slot 22 extends in the same direction as the axial direction of the mounting opening 24. The elastic fixing assembly 23 may be installed into the mounting slot 22 through the mounting opening 24. The bridge 2 is provided with a cover 25. The cover 25 closes the mounting opening 24.

In this implementation, by providing the mounting opening 24, the elastic fixing assembly 23 may be conveniently mounted in the mounting slot 22. During assembly, the elastic fixing assembly 23 may be first installed into the mounting slot 22 through the mounting opening 24, then the mounting opening 24 may be covered with the cover 25, and the cover 25 may be fixedly connected to the glasses 100 by means of bonding or welding or through a fastener 26, etc. The fastener 26 may be a screw, one end of which passes through the cover 25 and connected to the bridge 2. Upon completion of the assembly, one end of the elastic member 232 of the elastic fixing assembly 23 abuts against the cover 25, and the other end of the elastic member 232 abuts against the abutting member 231. The mounting slot 22 may extend in the thickness direction of the frame of the glasses 100, and the mounting opening 24 may be located on a side of the glasses 100 facing away from a wearer.

The abutting member 231 and the elastic member 232 of the elastic fixing assembly 23 may be separately provided without connection therebetween. The abutting member 231 and the elastic member 232 of the elastic fixing assembly 23 may also be integrally provided to form a single component, so as to facilitate assembly. For example, the elastic fixing assembly 23 may further include a housing, which has a cavity. One end of the abutting member 231 is slidably arranged in the cavity, and the other end of the abutting member 231 protrudes out of the cavity. The elastic member 232 is arranged in the cavity, and the elastic member 232 is capable of abutting against the abutting member 231. The glasses 100 are provided with the mounting slot 22. The housing of the elastic fixing assembly 23 is directly inserted into the mounting slot 22. The housing may be fixed to the mounting slot 22 by means of bonding or welding or through a fastener 26, etc. Alternatively, the housing does not need to be fixed to the frame. Instead, a cover is mounted on the frame, and the cover 25 covers the mounting opening 24. The cover functions to limit the housing, so that the housing is stably in the mounting slot 22.

Optionally, the abutting member 231 and the elastic member 232 of the elastic fixing assembly 23 are separately provided. Referring to FIG. 8, the elastic member 232 may include a cylindrical body 2321, an end plate 2322, a spring 2323, and a protruding post 2324. The cylindrical body 2321 has a cavity. One end of the cylindrical body 2321 is provided with a through hole in communication with the cavity, and the other end of the cylindrical body 2321 is closed by the end plate 2322. A slider is provided at one end of the protruding post 2324, and the slider is slidably connected to the cavity. The protruding post 2324 extends out through the through hole. The spring 2323 is located in the cavity, and one end of the spring 2323 abuts against the slider of the protruding post 2324, and the other end of the spring abuts against the end plate 2322. The elastic member 232 may be inserted into the mounting slot 22. The cylindrical body 2321 may be fixed to the mounting slot 22. The protruding post 2324 of the elastic member 232 abuts against the abutting member 231.

Referring to FIGS. 1, 2, 5, 8, and 9, embodiments of the present disclosure further provide a glasses assembly. The glasses assembly includes glasses 100 and a nose piece 200. The glasses 100 may be the glasses 100 provided in Embodiment 1 described above. The nose piece 200 has a bracket 220 and contact portions 210 connected to the bracket. When a user wears the glasses assembly, the contact portions 210 of the nose piece can be supported on the user's nose. The bracket 220 has an insertion portion 2201. In a state where the insertion portion 2201 is inserted into a nose piece slot 21, an elastic fixing assembly 23 abuts against the insertion portion 2201 to secure the nose piece 200.

During movement of the insertion portion 2201 in the direction away from the nose piece slot 21, the insertion portion 2201 applies an external force to an abutting member 231, compressing an elastic member 232.

The frame includes a first frame portion 1a, a second frame portion 1b, and a bridge 2. The bridge 2 is located between the first frame portion 1a and the second frame portion 1b, and the bridge 2 connects the first frame portion 1a and the second frame portion 1b. The bridge 2 is provided with the nose piece slot 21 and the elastic fixing assembly 23. The elastic fixing assembly 23 has the abutting member 231 and the elastic member 232. The abutting member 231 has a smooth surface. The elastic fixing assembly 23 is configured such that under the action of the elastic member 232, the abutting member 231 extends into the nose piece slot 21, and under the action of the external force, the abutting member 231 draws back in the direction away from the nose piece slot 21. The glasses 100 are configured such that in a state where the insertion portion 2201 of the nose piece 200 is inserted into the nose piece slot 21, the abutting member 231 abuts against the insertion portion 2201 to secure the nose piece 200.

Referring to FIGS. 5, 9 and 10, the insertion portion 2201 of the nose piece 200 may be provided with a positioning fit hole 2201a. After the insertion portion 2201 is inserted into the nose piece slot 21, the abutting member 231 may partially extend into the positioning fit hole 2201a, limiting the position of the nose piece 200 in the insertion/removal direction, and preventing the nose piece 200 from falling off. The abutting member 231 may have a curved convex outer surface. The convex outer surface may be a spherical surface. In a state where the abutting member abuts against the insertion portion, the spherical surface partially extends into the positioning fit hole 2201a, and is partially located on an outer side of the positioning fit hole 2201a. The surface of the curved convex outer surface has a smooth transition, which facilitates smoother insertion and removal of the insertion portion 2201, thereby making the operations convenient and providing a good use experience.

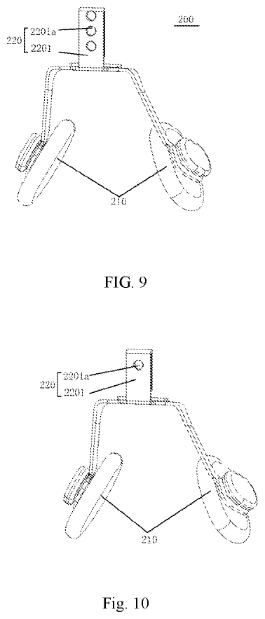

In embodiments of the present disclosure, referring to FIG. 10, the insertion portion 2201 may be provided with one positioning fit hole 2201a. Referring to FIG. 9, the insertion portion 2201 may also be provided with two or more positioning fit holes 2201a. The positioning fit holes 2201a are spaced apart sequentially along the length direction of the insertion portion 2201. In this way, a position of the nose piece 200 relative to the glasses 100 can be adjusted, and during insertion of the insertion portion 2201 into a slot of a temple 3, an insertion depth of the insertion portion 2201 can be adjusted, allowing the abutting member 231 to be pressed against different positioning fit holes 2201a, making it convenient for different users to adjust the insertion depth of the nose piece 200, and facilitating adjustment of a frame height to a position for an optimal visual angle for a user.

The insertion portion 2201 on the bracket of the nose piece may be a two-layer structure formed by bending a thin steel sheet, and may be formed with the mating hole 2201a on a side close to the abutting member 231. The insertion portion 2201 being designed as a two-layer structure increases the thickness, enabling close contact with the nose piece slot 21 to increase a frictional force, which facilitates stable insertion of the insertion portion 2201 into the nose piece slot 21 without being easily dislodged.

According to some optional embodiments of the present disclosure, glasses are provided. The glasses include a frame, which has a nose piece slot and an elastic fixing assembly. The nose piece slot extends in a first direction, and is configured for attachment and detachment of the nose piece. The elastic fixing assembly extends in a second direction, and is configured to secure the nose piece. The first direction and the second direction are substantially perpendicular to each other. The elastic fixing assembly has an abutting member and an elastic member. The elastic fixing assembly is configured such that under the action of the elastic member and the nose piece, the abutting member is capable of reciprocating in the second direction to secure or release the nose piece.

The abutting member is configured to contact the nose piece during attachment and detachment of the nose piece to secure or release the nose piece. In order to facilitate achieving the above function, the abutting member may have a smooth surface, or may have a curved surface.

Understandably, the second direction may be the thickness direction of the frame.

According to some optional embodiments of the present disclosure, glasses are provided. The glasses include a frame, which has a nose piece slot, a mounting slot, and an elastic fixing assembly. The mounting slot has an opening in communication with the nose piece slot. The elastic fixing assembly has an abutting member and an elastic member. The elastic member is arranged in the mounting slot. The elastic fixing assembly is arranged in such a manner that under the action of the elastic member, at least a portion of the abutting member extends through the opening into the nose piece slot to secure the nose piece, and under the action of the nose piece, the abutting member moves toward the mounting slot to release the nose piece. For example, during movement of the nose piece in the direction away from the nose piece slot, the nose piece applies an external force to the abutting member to cause the abutting member to release the nose piece.

The above description has been made for purposes of illustration and description. In addition, this description is not intended to limit the embodiments of the present disclosure to the forms disclosed herein. Although a plurality of example aspects and embodiments have been discussed above, certain variations, modifications, changes, additions, and sub-combinations thereof would occur to those skilled in the art.

1. A pair of glasses, comprising:
a first frame portion;
a second frame portion; and
a bridge located between the first frame portion and the second frame portion, connecting the first frame portion and the second frame portion, and provided with a nose piece slot and an elastic fixing assembly,
wherein the elastic fixing assembly has an abutting member and an elastic member, the abutting member has a smooth surface, and the elastic fixing assembly is configured such that under action of the elastic member, the abutting member extends into the nose piece slot, and under action of an external force, the abutting member draws back in a direction away from the nose piece slot,
wherein the glasses are configured such that in a state where an insertion portion of a nose piece is inserted into the nose piece slot, the abutting member abuts against the insertion portion to secure the nose piece.

2. The glasses according to claim 1, wherein the glasses are further configured such that during movement of the insertion portion of the nose piece away from the nose piece slot, the nose piece applies the external force to the abutting member, causing the abutting member to draw back in the direction away from the nose piece slot to release the nose piece.

3. The glasses according to claim 1, wherein the abutting member has a curved surface.

4. The glasses according to claim 1, wherein the abutting member is a cap having a top end and a cavity, the cavity of the cap being configured to accommodate at least a portion of the elastic member, and under the action of the elastic member, the top end of the cap extending into the nose piece slot.

5. The glasses according to claim 1, wherein the abutting member comprises:
a pressing portion extending into the nose piece slot and having a smooth convex outer surface; and
a main body portion having an outer diameter different from that of the pressing portion, and provided with a recessed portion located at an end facing away from the pressing portion, the recessed portion being configured to accommodate the elastic member.

6. The glasses according to claim 1, wherein the bridge is provided with a mounting slot, an extension direction of the mounting slot is perpendicular to an extension direction of the nose piece slot, and the mounting slot is in communication with the nose piece slot;
the elastic member is arranged in the mounting slot, and the abutting member is slidably connected to the mounting slot, and under the action of the elastic member, the abutting member partially extends into the nose piece slot; and
an insertion/removal direction of the insertion portion is perpendicular to a sliding direction of the abutting member.

7. The glasses according to claim 6, wherein the mounting slot has a main slot and a necked slot, the necked slot is in communication with the main slot and the nose piece slot;
the abutting member is slidably arranged in the main slot; and
the elastic member is located in the main slot, with one end of the elastic member abutting against the abutting member, such that the abutting member is partially limited within the main slot and partially extends into the nose piece slot through the necked slot.

8. The glasses according to claim 7, wherein the necked slot is configured in any one of the following manners:
an inner wall defining the necked slot is cylindrical, and a limiting step surface is formed between the necked slot and the main slot; or
an inner wall defining the necked slot is a tapered wall tapering in a direction from the main slot to the nose piece slot.

9. The glasses according to claim 7, wherein the abutting member is spherical, the abutting member has a diameter greater than an inner diameter of the necked slot, and the diameter of the abutting member is less than an inner diameter of the main slot; and
under abutment of the elastic member, the abutting member rests against the necked slot, and the abutting member partially extends into the nose piece slot.

10. The glasses according to claim 7, wherein the abutting member comprises a main body portion and a pressing portion;
the main body portion has a cross-sectional diameter greater than an inner diameter of the necked slot, and the pressing portion has a cross-sectional diameter less than the inner diameter of the necked slot;
the main body portion is slidably arranged in the main slot, and the pressing portion is connected to the main body portion; and
the elastic member abuts against the main body portion, such that the main body portion rests against the necked slot, and the pressing portion extends into the nose piece slot through the necked slot.

11. The glasses according to claim 6, wherein the bridge is provided with a mounting opening in communication with the mounting slot, the mounting slot extending in a same direction as an axial direction of the mounting opening;
the elastic fixing assembly is installed into the mounting slot through the mounting opening; and
the bridge is provided with a cover closing the mounting opening.

12. The glasses according to claim 1, wherein the abutting member and the elastic member are sequentially arranged along a thickness direction of the first frame portion; and
the abutting member is capable of reciprocating in the thickness direction of the first frame portion to compress or release the elastic member.

13. A glasses assembly, comprising:
pair of glasses, wherein the pair of glasses comprise:
a first frame portion;
a second frame portion; and
a bridge located between the first frame portion and the second frame portion, connecting the first frame portion and the second frame portion, and provided with a nose piece slot and an elastic fixing assembly,
wherein the elastic fixing assembly has an abutting member and an elastic member, the abutting member has a smooth surface, and the elastic fixing assembly is configured such that under action of the elastic member, the abutting member extends into the nose piece slot, and under action of an external force, the abutting member draws back in a direction away from the nose piece slot,
wherein the glasses are configured such that in a state where an insertion portion of a nose piece is inserted into the nose piece slot, the abutting member abuts against the insertion portion to secure the nose piece; and
a nose piece, the nose piece having an insertion portion, wherein
in a state where the insertion portion is inserted into the nose piece slot, the elastic fixing assembly abuts against the insertion portion to secure the nose piece.

14. The glasses assembly according to claim 13, wherein, during movement of the insertion portion in the direction away from the nose piece slot, the insertion portion applies an external force to the abutting member, compressing the elastic member.

15. The glasses assembly according to claim 13, wherein the insertion portion is provided with a plurality of positioning fit holes along the length direction; and
during insertion of the insertion portion into the nose piece slot, the elastic fixing assembly is configured to be inserted into any of the positioning fit holes.

16. The glasses assembly according to claim 13, wherein the nose piece has an insertion portion, in a state where the insertion portion is inserted into the nose piece slot, the elastic fixing assembly abuts against the insertion portion to secure the nose piece.

17. The glasses according to claim 13, wherein the abutting member is configured to contact the nose piece during attachment and detachment of the nose piece to secure or release the nose piece, and the abutting member have a smooth curved surface.

18. A pair of glasses comprising:
a frame having:
a nose piece slot,
a mounting slot having an opening in communication with the nose piece slot, and
an elastic fixing assembly having:
an abutting member; and
an elastic member arranged in the mounting slot,
wherein the elastic fixing assembly is arranged in such a manner that under action of the elastic member, at least a portion of the abutting member extends into the nose piece slot through the opening to secure a nose piece, and under action of the nose piece, the abutting member moves toward the mounting slot to release the nose piece.

19. The glasses according to claim 18, wherein during movement of the nose piece in a direction away from the nose piece slot, the nose piece applies an external force to the abutting member to cause the abutting member to release the nose piece.

20. The glasses according to claim 18, wherein the abutting member is configured to contact the nose piece during attachment and detachment of the nose piece to secure or release the nose piece, and the abutting member have a smooth curved surface.
